(19) United States
(12) Patent Application Publication
(10) Pub. No.: US 2006/0220379 A1
(43) Pub. Date: Oct. 5, 2006

(54) High-pressure resistant vibration absorbing hose and manufacturing method of the same

(76) Inventors: Tetsuyo Arima, Kasugai-shi (JP); Tomohide Ito, Kasugai-shi (JP); Norihiko Furuta, Komaki-shi (JP); Koichi Wakita, Komaki-shi (JP); Ayumu Ikemoto, Komaki-shi (JP)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/391,727

(22) Filed: Mar. 28, 2006

(30) Foreign Application Priority Data
Mar. 31, 2005 (JP) 2005-103018

(51) Int. Cl. B21K 1/16; F16L 33/00

(52) U.S. Cl. 285/256; 285/242; 285/259; 29/890.144

(57) ABSTRACT

A high-pressure resistant vibration absorbing hose includes an inner surface rubber layer, a reinforcing layer formed by braiding a reinforcing yarn in an outer side thereof at a high braiding density equal to or more than 50%, and an outer surface rubber layer, and has a joint metal fitting to an axial end portion, the caulked portion is formed in an expanded shape, and a braiding angle of the reinforcing yarn is set to 55 degree±2 degree in both of a caulked portion and a main portion.

### BACKGROUND OF THE INVENTION

1. Field of the Invention

The present invention relates to a high-pressure resistant vibration absorbing hose, and more particularly to a high-pressure resistant vibration absorbing hose which is preferably applied to a hose arranged within an engine room of a motor vehicle for piping, and a manufacturing method of the same.

2. Description of the Related Art

Conventionally, a hose structured mainly by a rubber layer is widely used as an industrial or vehicular hose for various intended uses.

A main object for using the hose mentioned above is to absorb a vibration.

For example, in the case of a piping hose arranged within an engine room of a motor vehicle, a hose part absorbs an engine vibration, a compressor vibration of an air conditioner (in the case of a cooling medium transport hose, that is, an air conditioner hose), and various vibrations generated in accordance with a vehicle travel, and the hose plays a role in suppressing the vibration being transmitted from one member connected via the hose to the other member.

Meanwhile, structures of an oil system, a fuel system, a water system and a cooling medium system hose is formed such as to have a reinforcing layer in which a reinforcing thread or yarns (a reinforcing filament member) is spirally wound at the midpoint of an inner surface side rubber layer (an inner surface side layer) and an outer surface rubber layer (an outer surface side layer), for example, as disclosed in the following patent document 1, without regard to the hose for the industry and the hose for the motor vehicle.

FIG. 8(A) shows a structure of a cooling medium transporting hose (an air conditioner hose) disclosed in the following patent document 1, and reference numeral 200 in the drawing denotes an inner surface side rubber layer. An inner surface of the inner surface side rubber layer 200 is coated with a resin inner layer 202.

The structure is made such that a first reinforcing layer 204 formed by spirally winding a reinforcing yarn is layered in an outer side of the inner surface side rubber layer 200, a second reinforcing layer 208 formed by spirally winding the reinforcing yarn in an inverted direction to the first reinforcing layer 204 is layered in an outer side of the first reinforcing layer via an intermediate rubber layer 206, and an outer surface rubber layer 210 is layered as a cover layer for an outermost layer.

The embodiment corresponds to an example in which the reinforcing layer is structured by spirally winding the reinforcing yarn, however, the reinforcing layer may be structured by braiding the reinforcing yarn.

FIG. 8(B) shows an example thereof, and reference numeral 212 in the drawing denotes a reinforcing layer formed by braiding a reinforcing yarn. The reinforcing layer 212 is formed between an inner surface side rubber layer 200 and an outer surface rubber layer 210.

In this case, an inner surface of the inner surface side rubber layer 200 is coated with the resin inner layer 202.

In the case of a straight tube-shaped hose as mentioned above, a predetermined length has been conventionally required for securing a good vibration absorbability.

Particularly, in a hose for resisting a higher pressure such as an oil system (for example, a hose for a power steering), a cooling medium system (a hose for transporting a cooling medium) and the like in comparison with a hose for a low pressure such as a fuel system, a water system or the like, a necessary length for absorbing a vibration and reducing propagation of a sound and a vibration to a passenger room becomes longer at a degree that a hose rigidity is high.

For example, in the case of the cooling medium transporting hose, even if a straight line distance to be connected is 200 mm, the vibration absorption and the reduction of propagation of the sound and the vibration are generally intended by using a hose having a length between 300 and 600 mm.

However, various apparatuses and parts are assembled within the engine room crowdedly, and particularly in recent years, the engine room is made more and more compact. If a length of the hose arranged there is large, it is hard to design a piping for avoiding an interference with the other elements and arrange the piping at a time of attaching the hose. Further, it is necessary to devise the piping design and the piping arrangement every vehicle types, and a great load has been generated.

In accordance with the matter mentioned above, there has been required a development of a hose which can well absorb a vibration by a short hose length.

As a means for shortening the hose while securing a vibration absorbability in the hose, there can be considered a structure of forming the hose in a bellows shape.

Here, if the hose is formed in the bellows shape, a flexibility is dramatically improved, but the hose is entirely elongated largely in an axial direction by the fluid high pressure applied to the inner portion thereof.

In this case, if both ends of the hose are in a fixed state (normally set so), the hose is entirely bent largely, and there is generated a problem that the hose causes an interference with the peripheral parts.

In other words, a countermeasure by forming in the bellows shape can not be sufficient.

In the case of the high-pressure resistant hose such as the air conditioner hose or the like, in a state in which the fluid is introduced to the inner portion at a high pressure, the hose and the fluid work together so as to show a behavior like a rigid body much more in comparison with the case that the pressure mentioned above is not applied.

A degree of making rigid becomes larger in accordance that a cross sectional area of a transverse section including the hose and the fluid or a cross-sectional area of an inner portion of the hose becomes larger.

Contrarily saying, if the cross sectional area of the hose and the fluid become small, the degree of making rigid becomes small, and a vibration absorbing performance increases at that degree.

Accordingly, in order to increase the vibration absorbing performance at a small length without forming the hose in the bellows shape, it is an effective means to make a diameter of the hose small.

However, if the hose including an axial end portion is simply made narrow as a whole, and a diameter of a joint device is also made small, an inner diameter of an insert pipe in the joint device becomes small, so that a pressure loss is generated in the same portion at a time of transporting the fluid, and it is impossible to secure a desired flow rate.

On the other hand, in the case of making a caulked portion of the axial end portion narrow, and further using a large-diameter joint device having an insert pipe having a large inner diameter, an inserting resistance becomes significantly large at a time of inserting the insert pipe to the caulked portion of the axial end portion for the installation, so that an inserting characteristic of the insert pipe is deteriorated, and it is actually hard to install the joint device.

Accordingly, even if the hose diameter is made small, it is desirable to keep the diameter of the caulked portion of the axial end portion as it is, and to make only the diameter of a main portion narrow.

In this case, the caulked portion of the axial end portion is formed relatively expanded shape with respect to the main portion.

As a means for manufacturing the hose or a hose main body in which the axial end portion is formed in the enlarged diameter shape, there can be considered a means for temporarily forming an unvulcanized hose in a straight tube shape, and thereafter expanding only the axial end portion, then applying a vulcanizing process.

For example, the following patent document 2 and patent document 3 disclose a technique that the axial end portion of the hose is formed in the expanded shape by inserting a mandrel mold to an end portion of the extrusion molded unvulcanized hose and vulcanizing under the state, in the water system hose such as a radiator hose or the like.

However, the hose disclosed in the patent document 2 and the patent document 3 corresponds to the water system hose and has a small bursting pressure, and a braiding density of the reinforcing layer is low between about 15 and 25%. Accordingly, in this case, a difficulty of the expanding work is not so large.

However, in a high density and high-pressure resistant hose in which the bursting pressure is equal to or more than 5 MPa and the braiding or winding density of the reinforcing layer is equal to or more than 50%, a resistance by the reinforcing layer is dramatically increased at a time of extruding the mandrel mold, and the expanding work becomes hard all at once.

Further, in the case of expanding the axial end portion as mentioned above, there is generated a problem that a braiding or winding angle of the reinforcing yarn of the reinforcing layer is changed (increased) in the caulked portion having the expanded shape.

In detail, in both of the low-pressure resistant hose such as the water system hose or the like and the high-pressure resistant hose having the high braiding or winding density, the braiding or winding angle of the reinforcing yarn in the reinforcing layer is generally set to an angle close to a neutral angle (55 degree). However, if the caulked portion is formed by expanding the axial end portion under the state, there are generated a problem that the braiding or winding angle of the reinforcing yarn becomes larger than a proper angle in the caulked portion, and a problem that the braiding or winding angles of the reinforcing yarn become nonuniform in the caulked portion and the main portion.

In this case, the following meaning exists in setting the braiding or winding angle of the reinforcing yarn to the neutral angle.

For example, if the braiding or winding angle is larger than the neutral angle, the reinforcing layer is elongated in a longitudinal direction as a whole in a direction of setting the braiding or winding angle of the reinforcing yarn to the neutral angle due to an internal pressure applied thereto as shown in FIG. 9(a) (the reinforcing layer is contracted in the diametrical direction at this time), and a deforming amount becomes large. Further, on the other hand, if the braiding or winding angle of the reinforcing yarn in the reinforcing layer is smaller than the neutral angle as shown in FIG. 9(c), the reinforcing layer is expanded in the diametrical direction in the direction of setting the braiding or winding angle to the neutral angle at a time when the internal pressure is applied (the reinforcing layer is contracted in the longitudinal direction at this time), and the deforming amount becomes large in the same manner.

On the contrary, if the braiding or winding angle is set to the neutral angle or the angle close thereto, it is possible to prevent and suppress the hose from being deformed in the longitudinal direction and the diametrical direction even in the case that the internal pressure is applied as shown in FIG. 9(b).

Accordingly, if the braiding or winding angle of the reinforcing yarn in the caulked portion having the expanded shape becomes larger than the neutral angle, the deformation of the caulked portion is promoted, and the deformation becomes nonuniform between the caulked portion and the main portion due to the difference of the braiding or winding angle, when a high pressure is exerted or applied thereto by the transported fluid repeatedly. Therefore, there is a problem that the hose performance such as a pressure resistance, a durability or the like is deteriorated and destabilized.

Further, since a thickness of the caulked portion becomes small on the basis of the expansion, there is generated a problem that a caulked portion is disconnected by caulking and fixing the joint device if the thickness (the thickness of the inner surface side layer) becomes equal to or less than a fixed level.

In the caulked portion of the axial end portion in the hose, it is necessary to generally set a compression rate about 25 to 50% taking a dispersion of the thickness and a fastening strength into consideration. However, if the thickness of the caulked portion of the axial end portion becomes equal to or thinner than a fixed level due to the expansion, there is generated a problem that the caulked portion, particularly the caulked portion in the inner surface side layer generates the caulked disconnection at a time of caulking and fixing the joint device (in this connection, the hoses disclosed in the patent document 2 and the patent document 3 are not based on the aspect of caulking and fixing the joint device, and do not generate the problem mentioned above).

[Patent Document 1]

JP-U, 7-68659

[Patent Document 2]

JP-B, 3244183

[Patent Document 3]

JP-B, 8-26955

The present invention is made by taking the circumstance mentioned above into consideration, and an object of the present invention is to provide a high-pressure resistant vibration absorbing hose formed by caulking and fixing a joint device to an axial end portion, which has an improved vibration absorbing performance, can secure a desired flow rate at a time of transporting a fluid, can avoid the problem of the caulked disconnection, and has a good and stable performance for the hose, and a manufacturing method of the same.

### SUMMARY OF THE INVENTION

In accordance with the present invention, there is provided a novel high-pressure resistant vibration absorbing hose having a bursting pressure equal to or more than 5 MPa. The high-pressure resistant vibration absorbing hose is provided with a hose main body having an inner surface side layer (for example, an inner surface layer), a reinforcing layer formed by braiding or spirally winding a reinforcing filament member at a high density equal to or more than 50% and arranged in an outer side of the inner surface side layer, and an outer surface layer arranged in an outer side of the reinforcing layer and corresponding to a cover layer. The hose main body is provided with a caulked portion of an axial end portion, and a main portion. The high-pressure resistant vibration absorbing hose is further provided with a joint device having a rigid insert pipe inserted in the caulked portion, and a sleeve-like socket metal fitting fitted to an outer surface of the caulked portion. The joint device is fixed to the caulked portion to which the insert pipe is inserted, by caulking the socket metal fitting fitted to the outer surface of the caulked portion in a contracting direction. In the high-pressure resistant vibration absorbing hose in accordance with the present invention, the caulked portion of the axial end portion is formed in an expanded shape with respect to the main portion in a shape before caulking and fixing the joint device, and a braiding or spirally winding angle of the reinforcing filament member in the reinforcing layer is set to 55 degree±2 degree equivalently in both of the main portion and the caulked portion formed in the expanded shape. That is, braiding or spirally winding angles in the caulked portion and the main portion are equivalent, and set to an angle or angle range (55 degree (neutral angle)±2 degree). In the high-pressure resistant vibration absorbing hose in accordance with the present invention, a thickness of the inner surface side layer or the inner surface layer is equal to or more than 1 mm in the shape before caulking and fixing the joint device.

In this case, the braiding or spirally winding density corresponds to a rate of an area of the reinforcing filament member or yarn in the reinforcing layer, and the braiding or spirally winding density becomes 100% in the case that a gap between the reinforcing filament members is zero. More specifically, the braiding or spirally winding density is calculated as (yarn width×No. of yarns/(2×π×outer diameter of an inner surface side layer×cos braiding or winding angle) )×100.

Further, in accordance with the present invention, there is provided a novel manufacturing method of a high-pressure resistant vibration absorbing hose having a bursting pressure equal to or more than 5 MPa. The high-pressure resistant vibration absorbing hose having the bursting pressure equal to or more than 5 MPa manufactured by the manufacturing method is provided with a hose main body having an inner surface side layer (for example, an inner surface layer), a reinforcing layer formed by braiding or spirally winding a reinforcing filament member at a high density equal to or more than 50% and arranged in an outer side of the inner surface side layer, and an outer surface layer arranged in an outer side of the reinforcing layer and corresponding to a cover layer. The hose main body is provided with a caulked portion of an axial end portion, and a main portion. The manufactured high-pressure resistant vibration absorbing hose is further provided with a joint device having a rigid insert pipe inserted in the caulked portion, and a sleeve-like socket metal fitting fitted to an outer surface of the caulked portion. The joint device is fixed to the caulked portion to which the insert pipe is inserted, by caulking the socket metal fitting fitted to the outer surface of the caulked portion in a contracting direction. In the manufactured high-pressure resistant vibration absorbing hose, the caulked portion of the axial end portion is formed in an expanded shape with respect to the main portion in a shape before caulking and fixing the joint device, and a braiding or spirally winding angle of the reinforcing filament member in the reinforcing layer is set to an angle or angle range (55 degree±2 degree) and to be equivalent in both of the main portion and the caulked portion formed in the expanded shape. In the manufactured high-pressure resistant vibration absorbing hose, a thickness of the inner surface side layer or the inner surface layer equal to or more than 1 mm in the shape before caulking and fixing the joint device.

Further, in a manufacturing method of a high-pressure resistant vibration absorbing hose in accordance with the present invention, the method comprises a step of extrusion molding an inner surface side rubber layer (for example, an inner surface rubber layer) corresponding to an inner surface side layer in a long straight tube shape (a first step), and a step of braiding or spirally winding a reinforcing filament member in an outer periphery of the inner surface side rubber layer so as to continuously form a reinforcing layer (a second step) after extrusion molding (after the first step). At this time (at a time of the second step), in a portion to be formed as a caulked portion, the reinforcing filament member is braided or spirally wound at a smaller angle than an angle (55 degree±2 degree), or at an angle smaller than 53 degree, and in the main portion, the reinforcing filament member is braided or spirally wound at an angle which is larger than the angle of the reinforcing filament member braided or spirally wound in the portion to be formed as the caulked portion and is within an angle range (55 degree±2 degree), and the braiding or spirally winding of the reinforcing filament member in the portion to be formed as the caulked portion and the braiding or spirally winding of the reinforcing filament member in the main portion are alternately repeated in a longitudinal direction. A long intermediate molded product is formed by further extrusion molding an outer surface rubber layer corresponding to an outer surface layer in an outer periphery of the reinforcing layer (a third step). Further, the method cuts the long intermediate molded product per a predetermined hose length or a predetermined hose main body length at the portion to be formed as the caulked portion (a fourth step), thereafter (after the fourth step), intrudes a mandrel mold to an axial end portion of the cut hose main body so as to expand the axial end portion at a predetermined expanding rate and form the caulked portion, set or enlarge an angle (enlarged angle) of the reinforcing filament member at the caulked portion within an angle range (55 degree±2 degree), and thereafter applying a vulcanizing process so as to obtain the high-pressure resistant vibration absorbing hose or the hose main body. A joint device, which has a rigid insert pipe inserted in the caulked portion, and a sleeve-like socket metal fitting fitted to an outer surface of the caulked portion, is fitted to the caulked portion by caulking the socket metal fitting fitted to the outer periphery of the caulked portion to which the insert pipe is inserted in a contracting direction.

In the manufacturing method in accordance with the present invention, it is possible to apply a semi-vulcanizing process to the intermediate molded product or the cut hose main body prior to the intrusion of the mandrel mold.

In the manufacturing method in accordance with the present invention, it is possible to expand and deform the axial end portion or the portion to be formed as the caulked portion by constraining and holding an outer surface of the main portion by a holding mold at a time of intruding the mandrel mold, and intruding the mandrel mold in this state.

In the manufacturing method in accordance with the present invention, it is further possible to execute the intrusion of the mandrel mold in a state in which an internal pressure is applied to the hose main body.

As mentioned above, in accordance with the present invention, the caulked portion of the axial end portion is formed in the expanded shape with respect to the main portion in the shape before caulking and fixing the joint device, the thickness of the inner surface side layer or the inner surface layer is set to be equal to or more than 1 mm, and the braiding or spirally winding angle of the reinforcing filament member in the reinforcing layer is set to an angle or angle range (55 degree (neutral angle)±2 degree) in both of the main portion and the caulked portion formed as the expanded shape.

In the high-pressure resistant vibration absorbing hose in accordance with the present invention, since the caulked portion of the axial end portion is formed in the expanded shape in the shape before fixing the joint device in accordance with the caulking, it is possible to easily install the joint device thereto, and it is possible to make a difference between an inner diameter of the insert pipe in the joint device and an inner diameter of the main portion of the hose as small as possible or make the inner diameter of the insert pipe and the inner diameter of the main portion identical, whereby it is possible to suppress a pressure loss generated in the portion of the joint device at a time of transporting the fluid, and it is possible to easily secure a desired flow rate.

Further, in the present invention, since the thickness (the thickness of the inner surface side layer or inner surface layer) of the caulked portion is equal to or more than 1 mm, it is possible to prevent a problem that the caulked portion is disconnected due to the caulking and fixing of the joint device.

The present invention is characterized particularly by a point that the braiding or spirally winding angle of the reinforcing filament member of the reinforcing layer in the caulked portion having the expanded shape is set identical to the braiding or spirally winding angle of the main portion within an angle range (55 degree±2 degree). Accordingly, even in the case that the high pressure of the fluid is repeatedly applied as the internal pressure to the hose, it is possible to secure a resistance to deformation of the caulked portion, that is, to suppress an expanding and contracting deformation in the axial direction and the diametrical direction, and a degree of the deformation is equalized in the caulked portion and the main portion. Therefore, it is possible to prevent a great stress from being locally generated in the hose due to the non-uniformity of the deformation, whereby it is possible to prevent a hose performance such as a pressure resistance, a durability and the like from being deteriorated, and it is possible to apply a good and stable performance to the high-pressure resistant vibration absorbing hose.

In this case, the braiding or winding angle of the caulked portion and the braiding or winding angle of the main portion may not be strictly identical, and a difference (a dispersion) may exist therebetween within a range of ±2 degree or within a range of 2 degree.

The manufacturing method of the high-pressure resistant vibration absorbing hose in accordance with the present invention is structured such as to manufacture the high-pressure resistant vibration absorbing hose by braiding or spirally winding the reinforcing filament member at the smaller braiding or winding angle than an angle (55 degree±2 degree) with respect to the portion to be formed as the caulked portion at a time of braiding or spirally winding the reinforcing filament member in the outer periphery of the inner surface side rubber layer or the inner surface rubber layer corresponding to the inner surface side layer so as to continuously form the reinforcing layer, braiding or spirally winding the reinforcing filament member in the main portion at the angle which is larger than the angle of the reinforcing filament member braided or spirally wound in the portion to be formed as the caulked portion and is within an angle range of (55 degree±2 degree), alternately repeating the braiding or spirally winding of the reinforcing filament member in the portion to be formed as the caulked portion and the braiding or spirally winding of the reinforcing filament member in the main portion in the longitudinal direction, extrusion molding the outer surface rubber layer corresponding to the outer surface layer in the outer periphery of the reinforcing layer, thereafter cutting the long intermediate molded product in the portion to be formed as the caulked portion mentioned above per the predetermined hose length or the predetermined hose main body length, thereafter intruding the mandrel mold to the axial end portion of the hose main body so as to expand the axial end portion, forming the caulked portion so as to enlarge the braiding or spirally winding angle of the reinforcing filament member of the caulked portion to an angle or angle range (55 degree±2 degree) at that time, and thereafter applying the final vulcanizing process. In accordance with the manufacturing method, it is possible to easily manufacture the high-pressure resistant vibration absorbing hose in which the braiding or spirally winding angle is constituted by the neutral angle in both of the main portion and the caulked portion.

In this case, the braiding or spirally winding angle of the portion to be formed as the caulked portion before being expanded may be set to approximately 51 degree (51 degree±2 degree). Since the expanding rate of the caulked portion is not uniform, the braiding or spirally winding angle of the portion to be formed as the caulked portion before being expanded is not constant.

In this case, it is possible to apply the semi-vulcanizing process to the intermediate molded product or the cut hose main body (the hose body or the cut hose body) prior to the intrusion of the mandrel mold mentioned above.

In accordance with the structure mentioned above, it is possible to easily expand the axial end portion of the hose on the basis of the thereafter intrusion of the mandrel mold.

Next, if the outer surface of the main portion mentioned above is constrained and held by the holding mold at a time of intruding the mandrel mold mentioned above, and the expansion is achieved by intruding the mandrel mold to the axial end portion in this state, it is possible to well prevent the axial end portion or the cut hose main body (the hose body or the cut hose body) from generating a buckling on the basis of the intrusion force of the mandrel mold in the axial direction and it is possible to well expand and deform the axial end portion, because the outer surface of the main portion is constrained and held by the holding mode at a time of intruding the mandrel mold to the axial end portion and the inner portion so as to expand the axial end portion.

If the reinforcing filament member in the reinforcing layer is braided or spirally wound at a high braiding or spirally winding density equal to or more than 50% for applying a high-pressure resistant performance to the hose, a resistance at a time of intruding the mandrel mold to the axial end portion and the inner portion so as to expand is large. Accordingly, there tends to be generated a problem that the axial end portion generates the buckling in the axial direction in accordance with the intrusion of the mandrel mold. However, in accordance with one aspect of the present invention, the problem mentioned above is not generated, and it is possible to smoothly intrude the mandrel mold to the inner portion of the axial end portion on the basis of the constraining and holding effect obtained by the holding mold, whereby it is possible to well expand the axial end portion.

Further, if the internal pressure is applied to the hose body at a time of intruding the mandrel mold so as to apply an expansion force in the diametrical direction, and the mandrel mold is intruded under the state, it is possible to more easily expand and deform the axial end portion on the basis of the intrusion of the mandrel mold.

A description will be given below of an embodiment in accordance with the present invention with reference to the accompanying drawings.

### BRIEF DESCRIPTION OF THE DRAWINGS

FIG. 1(A) is a view showing a hose in accordance with an embodiment of the present invention;

FIG. 1(B) is a view showing a layered structure of a hose main body;

FIG. 2 is a cross sectional view showing a main portion of the hose in FIG. 1 in an enlarged manner;

FIG. 3(A) is a view showing the hose main body in FIG. 1 before fixing a joint metal fitting;

FIG. 3(B) is an enlarged view of a portion B in FIG. 3(A);

FIG. 4(A) is a view explaining one example of a manufacturing method of the hose in FIG. 1, and a view showing a first step;

FIG. 4(B) is a view explaining one example of the manufacturing method of the hose in FIG. 1, and a view showing a second step;

FIG. 4(C) is a view explaining one example of the manufacturing method of the hose in FIG. 1, and a view showing a third step and a fourth step;

FIG. 4(D) is a view explaining one example of the manufacturing method of the hose in FIG. 1, and a view showing a fifth step;

FIG. 5(A) is a view explaining the fifth step, and a view showing a state before intruding a mandrel mold;

FIG. 5(B) is a view explaining the fifth step, and a view showing a state in which the axial end portion of the hose body is expanded by intruding the mandrel mold;

FIG. 5(C) is a view explaining the fifth step, and a view showing a vulcanizing process;

FIG. 6(A) is a view explaining a different expanding method of the axial end portion of the hose body from FIG. 5, and a view showing a state before intruding the mandrel mold;

FIG. 6(B) is a view explaining the different expanding method of the axial end portion of the hose body from FIG. 5, and a view showing a state in which the axial end portion of the hose body is expanded by intruding the mandrel mold;

FIG. 7 is an explanatory view of a test method of high temperature repeated pressure durability;

FIG. 8(A) is a view showing an example of a conventionally known hose;

FIG. 8(B) is a view showing the other example of the conventionally known hose; and

FIG. 9 is an explanatory view showing a relation of an expansion and contraction in accordance with a braiding or winding angle of a reinforcing layer.

### BEST MODE FOR CARRYING OUT THE INVENTION

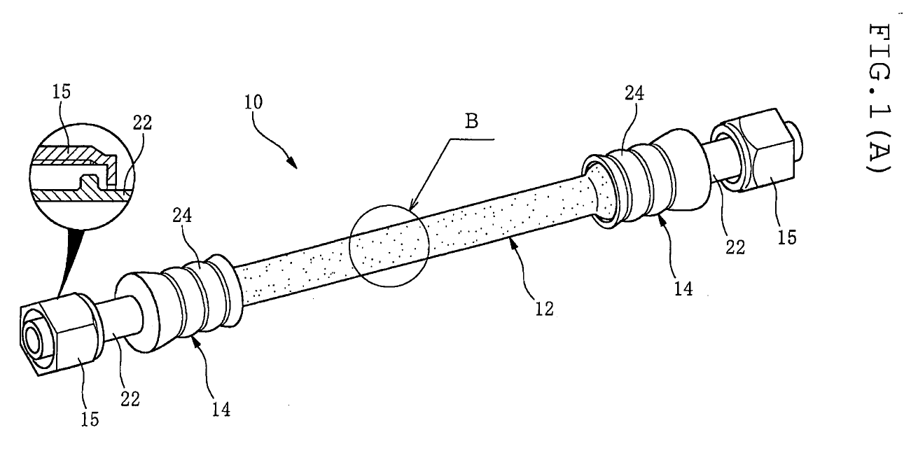

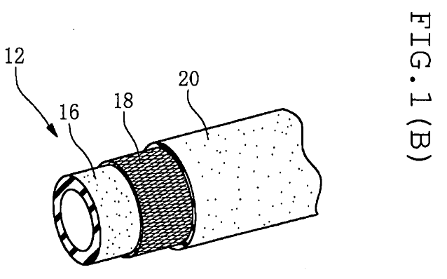

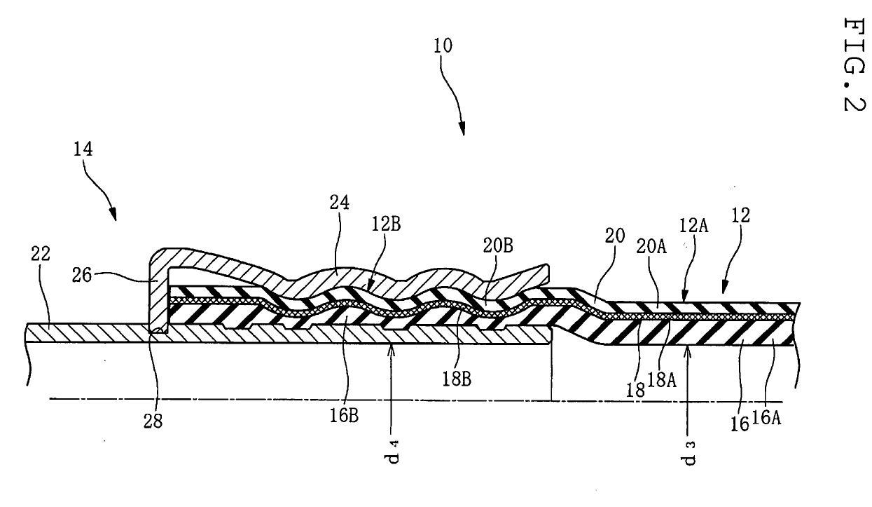

In FIG. 1, reference numeral 10 denotes a high-pressure resistant vibration absorbing hose (hereinafter, refer simply to as a hose), for example, used as a cooling medium transporting hose (an air conditioner hose) or the like. The hose 10 has a hose main body 12, and a pair of joint metal fittings (a joint device) 14, 14 fixed to a caulked portions 12B, 12B (refer to FIG. 2) of both axial end portions by means of caulking.

The hose main body 12 is structured by laminating an inner surface rubber layer (an inner surface layer or inner surface side layer) 16, a reinforcing layer 18 formed by braiding a reinforcing yarn (a reinforcing filament member) in an outer side thereof, and an outer surface rubber layer (an outer surface layer) 20 serving as a cover layer of an outermost layer, as shown in FIGS. 1(B).

In this case, for the reinforcing yarn or filament member forming the reinforcing layer 18, polyethylene terephthalate (PET), polyethylene naphthalate (PEN), aramid, polyamide or nylon (PA), vynilon, rayon, metal wire or the like may be adapted.

Further, the inner surface rubber layer 16 may be formed from a single material or a blended material of isobutylene-isoprene rubber (IIR), halogenated IIR (chloro-IIR (Cl—IIR or CIIR), bromo-IIR (Br—IIR or BIIR)), acrylonitrile-butadiene-rubber (NBR), chloroprene rubber (CR), ethylene-propylene-diene-rubber (EPDM), ethylene-propylene copolymer (EPM), fluoro rubber or fluorinated rubber (FKM), epichlorohydrin rubber or ethylene oxide copolymer (ECO), silicon rubber, urethane rubber, acrylic rubber or the like.

In this case, hydrofluorocarbon (HFC) type cooling medium transporting hose, the single material or the blended material of IIR or halogenated IIR is particularly preferable.

The outer surface rubber layer 20 may be formed also from every kind of rubber materials cited above as material for the inner surface rubber layer 16. In addition, heat-shrinkable tube and thermoplastic elastomer (TPE) are also applicable for the outer surface rubber layer 20. As for material of such heat-shrinkable tube and TPE, acrylic type, styrene type, olefin type, diolefin type, polyvinyl chloride type, urethane type, ester type, amide type, fluorine type or the like may be applied.

As shown in FIG. 2, the joint metal fitting 14 has a rigid insert pipe 22 made of a metal, and a sleeve-like socket metal fitting 24, and is fixed to the hose main body 12 in accordance with a caulking by inserting the insert pipe 22 into a caulked portion 12B of an axial end portion in the hose main body 12, and fitting the socket metal fitting 24 to an outer surface of the caulked portion 12B, and then caulking in a diameter contracting direction, whereby setting the caulked portion 12B to a state of being pinched in an inside and outside direction by the insert pipe 22 and the socket metal fitting 24.

In this case, an inward annular locking portion 26 is provided in the socket metal fitting 24, and an inner peripheral end portion of the locking portion 26 is locked or engaged to an annular locking groove 28 in an outer peripheral surface of the insert pipe 22.

In this case, reference numeral 15 in FIG. 1 denotes a hexagon head nut rotatably attached to the insert pipe 22.

In the present embodiment, an inner diameter d₃ of the main portion 12A in the hose main body 12, particularly an inner diameter d₃ of the main portion 16A in the inner surface rubber layer 16, and an inner diameter d₄ of the insert pipe 22 are set to be identical, as shown in FIG. 2.

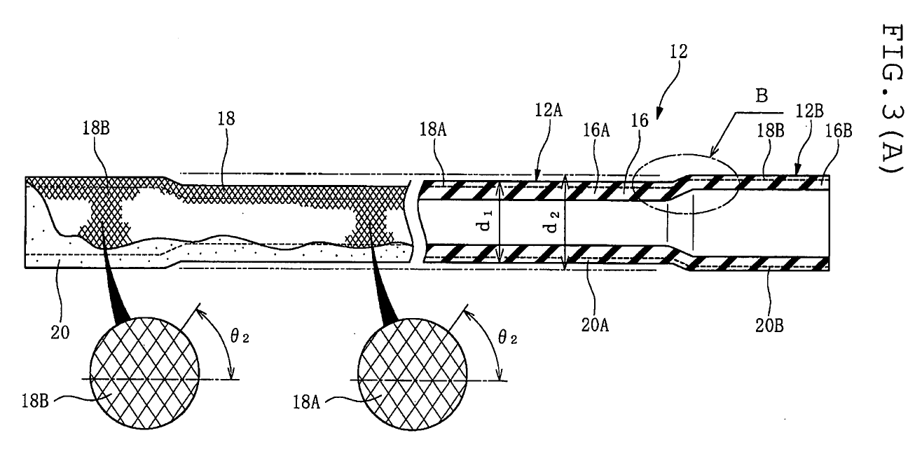

FIG. 3 shows a shape of the hose main body 12 before fixing the joint metal fitting 14.

In FIG. 3, reference numeral 12A denotes a main portion in the hose main body 12, and reference numeral 12B denotes a caulked portion of the axial end portion. As illustrated, in this embodiment, an outer diameter d, of the main portion 12A is narrower than an outer diameter d₂ of the caulked portion 12B.

In other words, the outer diameter of the main portion is identical with the outer diameter of the caulked portion in the conventional this type of hose, however, only the main portion 12A is narrowed here.

As a result, the caulked portion 12B is formed in an expanded shape with respect to the main portion 12A.

In this case, in FIG. 3, reference numeral 16A denotes a main portion in the inner surface rubber layer 16, and reference numeral 16B denotes a caulked portion in the inner surface rubber layer 16. Further, reference numeral 18A denotes a main portion in the reinforcing layer 18, and reference numeral 18B denotes a caulked portion in the reinforcing layer 18.

Further, reference numeral 20A denotes a main portion in the outer surface rubber layer 20, and reference numeral 20B denotes a caulked portion in the outer surface rubber layer 20.

In the present embodiment, as shown in FIG. 3(A), a braiding angle of a reinforcing yarn of the main portion 18A in the reinforcing layer 18 is set to a braiding angle θ₂ of (55 degree±2 degree) , and the braiding angle of the reinforcing yarn is set to the same braiding angle 02, in the caulked portion 18B of the axial end portion having the expanded shaped.

In this case, in the inner surface rubber layer 16, a thickness t₂ of the caulked portion 16B becomes smaller in comparison with a thickness t₁ of the main portion 16A as shown in FIG. 3(B). In this case, t₂ has a thickness equal to or more than 1 mm.

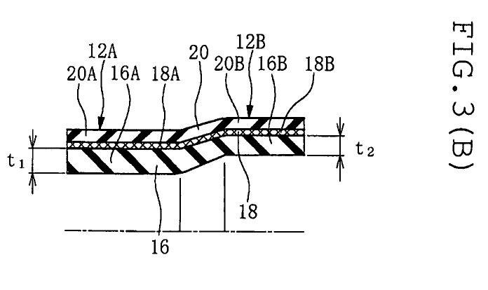

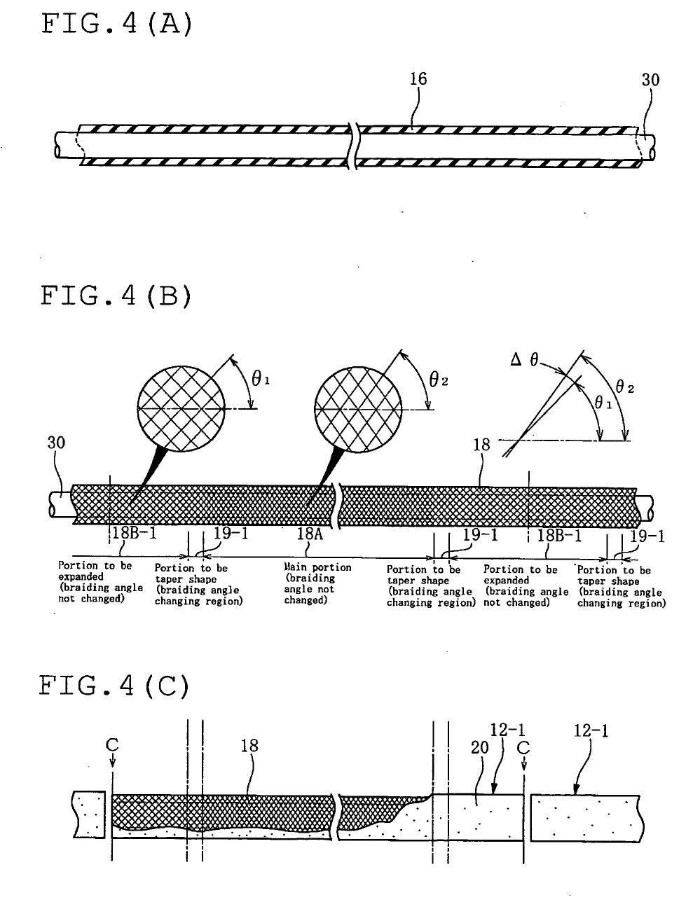

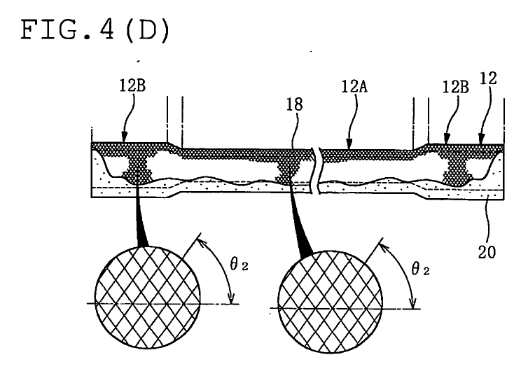

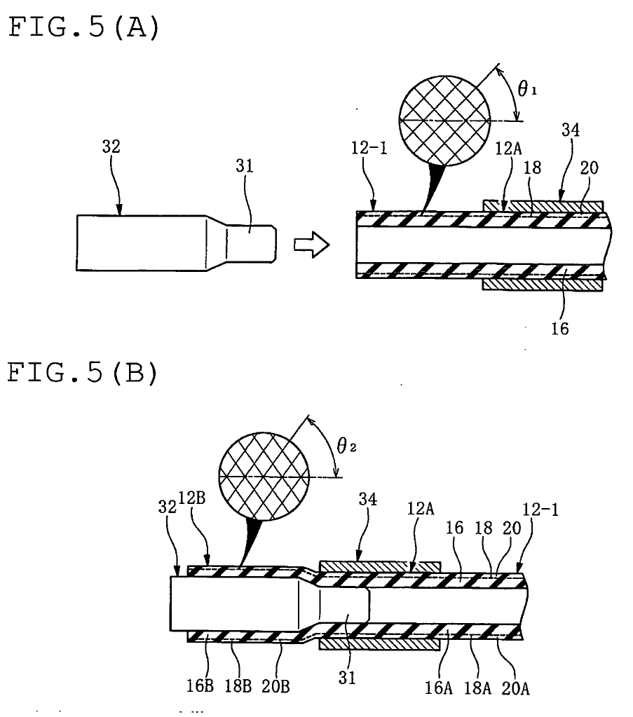

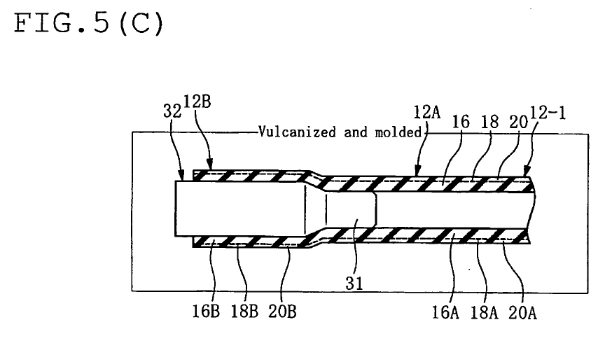

FIGS. 4 and 5 show a manufacturing method of the hose 10 in accordance with the present embodiment.

As shown in FIG. 4(A), in the manufacturing method, the inner surface rubber layer 16 is first extrusion molded in a long straight tube shape on an outer periphery of a mandrel 30 (a first step).

Thereafter, as shown in FIG. 4(B), the reinforcing layer 18 is continuously formed in an axial direction by braiding the reinforcing yarn on an outer periphery of the inner surface rubber layer 16 (a second step).

At this time, in a portion (a portion to be expanded) 18B-1 which is expanded later and is formed as the caulked portion, the reinforcing yarn is braided at a braiding angle θ₁ smaller than an angle (55 degree±2 degree) or 53 degree, for example, a braiding angle of 51 degree, in the main portion 18A, the reinforcing yarn is braided at a braiding angle θ₂ of (55 degree±2 degree), and these operations are alternately repeated in a longitudinal direction.

In this case, a transition portion (a portion to be taper shape) 19-1 is provided between the portion 18B-1 to be formed as the caulked portion and the main portion 18A.

The transition portion 19-1 corresponds to a portion formed as a taper shape in a boundary portion between the caulked portion 12B and the main portion 12A as shown in FIG. 4(D).

In this transition portion 19-1, the braiding angle of the reinforcing yarn is changed from the braiding angle θ₁ (the angle θ₀ is not changed) of the portion 18B-1 to be formed as the caulked portion toward the braiding angle θ₂ (the angle θ₂ is not changed)of the main portion 18A.

In this case, a length of the portion expressed by reference numeral 18B-1 in FIG. 4(B) is twice a length of the caulked portion 18B of the hose main body 12 (the hose 10 formed as a product shown in FIG. 1) shown in FIG. 4(D).

When the reinforcing layer 18 is formed as mentioned above, the outer surface rubber layer 20 (refer to FIG. 4(C)) is next continuously extrusion molded on the outer periphery of the reinforcing layer 18 long in a longitudinal direction (a third step).

Thereafter, the long intermediate molded product obtained as mentioned above is temporarily put in a semi-vulcanizing furnace so as to be semi-vulcanized, and the long intermediate molded product after being semi-vulcanized is thereafter cut per a predetermined hose length at an intermediate position (a cut position C in FIG. 4(C) in detail) of the portion to be formed as the caulked portion 12B, thereby forming a hose body 12-1 (a fourth step).

Next, as shown in FIG. 5, an axial end portion of the cut hose body 12-1 is expanded and deformed by using a mandrel mold 32 having a small-diameter portion 31 in a leading end portion.

In this case, the expansion of the axial end portion on the basis of the extrusion of the mandrel mold 32 is executed at an expansion rate of 33%.

Further, the caulked portion 12B mentioned above is formed as shown in FIG. 4(D) in accordance with the expanding deformation, and the braiding angle θ₁ of the portion 18B-1 to be formed as the caulked portion 18B which is initially smaller than the neutral angle, becomes larger up to (55 degree (neutral angle)±2 degree), and becomes the same angle as the braiding angle θ₂ in the main portion 18A.

The expanding deformation of the axial end portion can be executed by using a cylindrical holding mold 34 as shown in FIG. 5.

In detail, as shown in FIG. 5(A), the cylindrical holding mold 34 is fitted to the main portion 12A of the hose body 12-1 so as to constrain and hold the outer surface thereof, and the axial end portion is expanded to a shape corresponding to the shape and the outer diameter of the mandrel mold 32, by intruding the mandrel mold 32 to the axial end portion and the inner portion in an axial direction as shown in FIG. 5(B) under the state.

At this time, since the main portion 12A is constrained and held by the holding mold 34, the axial end portion does not generate a buckling even in the case of intruding the mandrel mold 32 against a resistance in an expanding direction of the reinforcing layer 18 (the caulked portion 18B in the reinforcing layer 18 in detail), and it is possible to well expand by the mandrel mold 32.

At this time, the thickness of the caulked portion 16B in the inner surface rubber layer 16 becomes smaller on the basis of the expanding deformation, however, the thickness t₂ (refer to FIG. 3(B)) of the caulked portion 16B is secured to be equal to or more than 1 mm after being expanded as mentioned above.

In other words, the thickness of the inner surface rubber layer 16, in particular, the thickness t₁ of the main portion 16A is defined such that the thickness t₂ of the caulked portion 16B in the inner surface rubber layer 16 after being expanded becomes equal to or more than 1 mm, at a time of expanding the axial end portion at the predetermined expanding rate on the basis of the insertion of the mandrel mold 32.

In this case, in the present embodiment, the thickness t₁ of the main portion 16A in the inner surface rubber layer 16 is set to a necessary thickness for applying a good vibration absorbing characteristic to the hose 10 and applying a permeability resistance, a water permeability resistance of the internal fluid on the other hand.

After intruding and inserting the mandrel mold 32 so as to expand the axial end portion as mentioned above, the hose body 12-1 is vulcanized in a state in which the mandrel mold 32 is inserted (FIG. 5(C)).

Further, if the vulcanizing process is finished, the mandrel mold 32 is taken out, the joint metal fitting 14 is fixed to the expanded caulked portion 12B of the hose main body 12 in accordance with the caulking.

In this case, the hose 10 shown in FIG. 1 is obtained.

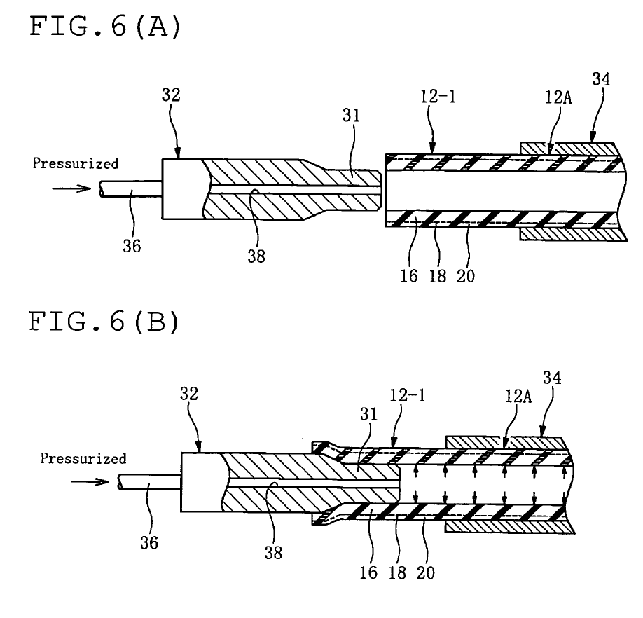

In FIG. 5, the structure is made such that the mandrel mold 32 is simply intruded and inserted to the axial end portion of the hose body 12-1, however, in the case that it is hard to intrude and insert the mandrel mold 32 on the basis of the resistance by the reinforcing layer 18, the structure may be made such that a pressurized fluid is introduced to an inner portion of the hose body 12-1 through a pipe body 36 and a passage 38 provided so as to pass through the mandrel mold 32 as shown in FIG. 6, and the mandrel mold 32 is intruded and inserted into the hose body 12-1 in a state in which an internal pressure is applied.

For example, there is a case that it is hard to intrude and insert the mandrel mold 32 in the case that the expanding rate is large, and it is possible to intrude and insert the mandrel mold 32 in a state in which the internal pressure is applied to the hose body 12-1 in the case mentioned above, whereby it is possible to smoothly intrude and insert the mandrel mold 32.

In the hose 10 in accordance with the present embodiment mentioned above, since the caulked portion 12B of the axial end portion is formed in the expanded shape in the shape before fixing the joint metal fitting 14 in accordance with the caulking, it is possible to easily install the joint metal fitting 14 thereto. Further, since the inner diameter d₄ of the insert pipe 22 in the joint metal fitting 14 and the inner diameter d₃ of the main portion 12A of the hose main body 12 are identical, it is possible to suppress the pressure loss generated in the portion of the joint metal fitting 14 at a time of transporting the fluid, and it is possible to easily secure a desired flow rate.

Further, in the present embodiment, since the thickness t₂ of the caulked portion 16B of the inner surface rubber layer 16 is set to be equal to or more than 1 mm, it is possible to prevent the problem that the caulked portion 16B generates the disconnection due to the caulking and fixing of the joint metal fitting 14.

Further, in the present embodiment, since the braiding angle of the reinforcing yarn in the caulked portion 12B is set to 55 degree±2 degree which is identical with the braiding angle of the main portion 12A, a deforming resistance of the caulked portion 12B is secured, that is, an expanding and contracting deformation in the axial direction and the diametrical direction is suppressed even in the case that the high pressure of the fluid is repeatedly applied as the internal pressure to the hose 10. Further, a degree of the deformation is uniformized in the caulked portion 12B and the main portion 12A, it is possible to prevent the matter that the great stress is locally generated in the hose 10 due to the non-uniformity of the deformation, whereby the hose performance such as the pressure resistance, the durability or the like is deteriorated, and it is possible to apply a good and stable performance to the hose 10.

Further, the manufacturing method of the hose 10 in accordance with the present embodiment is structured such as to manufacture the hose 10 by braiding the reinforcing yarn at the smaller braiding angle θ₁ than an angle (55 degree±2 degree) with respect to the portion 18B-1 to be formed as the caulked portion at a time of braiding the reinforcing yarn in the outer periphery of the inner surface rubber layer 16 so as to form the reinforcing layer 18, braiding the reinforcing yarn at the braiding angle θ₂ of 55 degree±2 degree with respect to the main portion 18A, alternately repeating these operations in the longitudinal direction, extrusion molding the outer surface rubber layer 20 in the outer periphery of the reinforcing layer 18, thereafter cutting the long intermediate molded product per the predetermined hose length at the portion to be formed as the caulked portion, intruding and inserting the mandrel mold 32 to the axial end portion of the cut hose body 12-1 so as to expand the axial end portion, forming the caulked portion 12B so as to expand the braiding angle of the reinforcing yarn of the caulked portion 18B up to (55 degree (neutral angle)±2 degree) at this time, and thereafter applying the final vulcanizing process. Accordingly, in spite that the caulked portion 12B is formed by expanding the axial end portion, it is possible to easily manufacture the hose 10 in which the braiding angle forms the neutral angle in both of the main portion 12A and the caulked portion 12B.

Further, in addition, in accordance with the present embodiment, since the intermediate molded product is semi-vulcanized prior to the intrusion of the mandrel mold 32 mentioned above, it is possible to easily expand the axial end portion on the basis of the thereafter intrusion and insertion of the mandrel mold 32.

Further, in the present embodiment, since the outer surface of the main portion 12A is constrained and held by the holding mold 34 at a time of intruding and inserting the mandrel mold 32, and the expansion is executed by intruding the mandrel mold 32 to the axial end portion in this state, it is possible to well prevent the axial end portion from generating the buckling due to the intrusion force in the axial direction of the mandrel mold 32, and it is possible to well expand the axial end portion. Meanwhile, the reinforcing layer 18 may be formed by spirally winding the reinforcing yarn.

### Embodiment

Hoses having various structures shown in Table 1 are manufactured, and there is evaluated an inserting characteristic of the mandrel mold 32 at a time of expansion, a length change rate at a time of pressurizing, a room temperature (RT) bursting pressure, and a high temperature repeated pressure resistance.

TABLE 1

| | | | Embodiment | | Comparative embodiment | | |
|---|---|---|---|---|---|---|---|
| | | | 1 | 2 | A | B | C |
| Hose | Demension | Inner | 9.0 | 14.5 | 9.0 | 9.0 | 16 |
| main | | diameter | | | | | |
| portion | | Outer | 16.0 | 22.0 | 16.0 | 14.4 | 24 |
| | | diameter | | | | | |
| | Inner surface | Material | C1-IIR | C1-IIR | C1-IIR | C1-IIR | EPDM |
| | rubber layer | Wall-thickness | 2.0 | 1.6 | 2.0 | 1.2 | 2.0 |
| | Reinforcing | Material | PET | PET | PET | PET | PA66 |
| | layer | No of | 1000 de | 3000 de | 1000 de | 1000 de | 1200 de |
| | | Denier | | | | | |
| | | No. of | 3 parallel | 22 | 3 parallel | 2 parallel | 22 |
| | | yarns | yarns × 48 | yarns × 2 | yarns × 48 | yarns × 48 | yarns × 2 |
| | | | carriers | spiraled | carriers | carriers | spiraled |
| | | Braiding/winding | 55.5 | 55 | 45 | 50 | 55.5 |
| | | angle (°) | | | | | |
| | | Density | 88 | 66 | 80 | 64 | 18 |
| | | (%) | | | | | |
| | Outer surface | Material | EPM | EPM | EPM | EPM | EPDM |
| | rubber layer | Wall-thickness | 1.0 | 1.0 | 1.0 | 1.0 | 1.0 |
| Caulked | Dimension | Inner diameter | 12 | 15.8 | 12 | 12 | 18 |
| portion | | Outer diameter | (17.9) | (22.4) | (17.9) | (16.4) | (25.4) |
| | Inner surface | Wall-thickness | (1.6) | (1.3) | (1.6) | (0.95) | (1.8) |
| | layer | | | | | | |
| | Reinforcing | Braiding/winding | 55 | 56 | 49 | 53 | 57 |
| | layer | angle (°) | | | | | |
| | Outer surface | Thickness | (0.9) | (0.9) | (0.9) | (0.85) | (0.95) |
| | layer | | | | | | |

| Expansion rate (%) | | 33 | 33 | 33 | 33 | 13 |
|---|---|---|---|---|---|---|
| Mandrel mold | no pressure | Good | Good | Acceptable | Inferior | Good |
| inserting | 0.2 MPa | — | — | Good | Acceptable | — |
| characteristic at | pressurizing | | | | | |
| expanding time | 0.5 MPa | — | — | Good | Good | — |
| | pressurizing | | | | | |
| | 1 MPa | — | — | Acceptable | Acceptable | — |
| | pressurizing | | | | | |

| | | | | | |
|---|---|---|---|---|---|
| Pressurizing time length | 0.1 | 0.4 | −8.8 | −5.0 | — |
| change rate (%) | | | | | |
| RT bursting pressure (Mpa) | 27.5 | 17.1 | 17.1 | 18.3 | 2.4 |
| High temperature repeated | No burst at | No burst at | Pin hole in | Pin hole in | — |
| pressure durability | one hundred | one hundred | hose center | caulked | |
| | thousands | thousands | portion at | portion at | |
| | | | thirty thousands | two thousands | |

* Unit of each of inner diameter, outer diameter and thickness is mm

In the line “No. of yarns” of the reinforcing layer of each of embodiment and comparative embodiment in Table 1, “3 parallel yarns×48 carriers” means that 3 parallel reinforcing yarns of 1000 denier (de) are braided on an 48 carrier machine.

Similarly, “2 parallel yarns×48 carriers” means that 2 parallel reinforcing yarns of 1000 denier (de) are braided on an 48 carrier machine.

And, “22 yarns×2 spiraled” means that a strand of 22 reinforcing yarns of 3000 de or 1200 de is wound spirally in one direction to form one ply and another strand of 22 reinforcing yarns of 3000 de or 1200 de is wound spirally in the reversed direction to laminate another ply over the one ply.

In this case, the inserting characteristic of the mandrel mold 32 at a time of expanding, the pressurizing time length change rate, the RT bursting pressure, and the high temperature repeated pressure durability in Table 1 are respectively evaluated, measured under the following conditions.

<Mandrel Mold Inserting Characteristic at Expanding Time>

The intruding and inserting characteristic of the mandrel mold 32 at a time of expanding the axial end portion at a time of manufacturing the hose is evaluated by three stages comprising “good”, “acceptable” and “inferior”.

In this case, the expanding method employs an expanding method under no pressure as shown in FIG. 5, and in the case that it is hard to employ the method (in the case that the evaluation is not “good”), the evaluation is executed by using a method shown in FIG. 6, that is, an expanding method of inserting the mandrel mold 32 in a state in which the internal pressure is applied to the inner portion of the hose body 12-1.

<Pressurizing Time Length Change Rate>

A length after pressurizing by 1.5 MPa×5 minutes is measured and a difference from the length before being pressurized is determined, whereby the change rate is calculated. Specifically, “pressurizing time length change rate” is calculated as ((free length of a hose main body of a hose after pressurized—free length of a hose main body of a hose before pressurized)/free length of a hose main body of a hose before pressurized)×100. Here, “free length of a hose main body of a hose” means a length of the hose main body of the hose extending between innermost caulked positions of the sleeve-like socket metal fittings 24.

<RT Bursting Pressure>

A water pressure is applied to an inner portion of the hose at a room temperature, is increased at a pressure increasing speed of 160 MPa/minute and the bursting pressure is expressed by a pressure reaching the burst.

<High Temperature Repeated Pressurizing Durability>

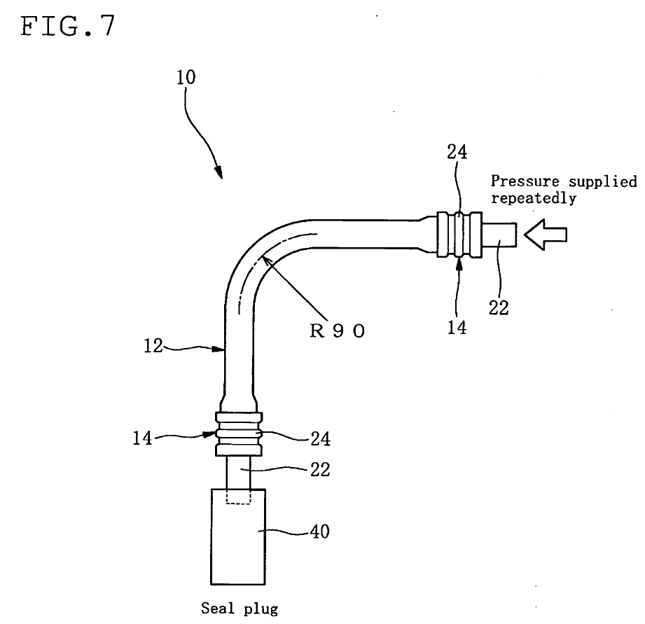

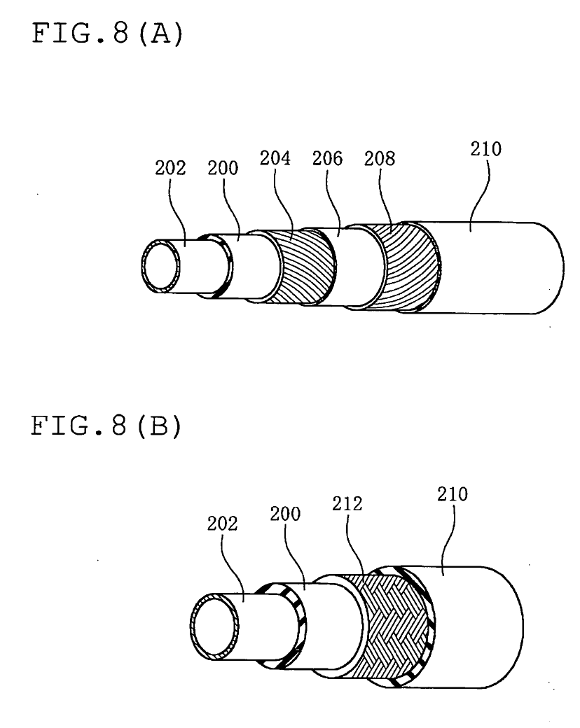

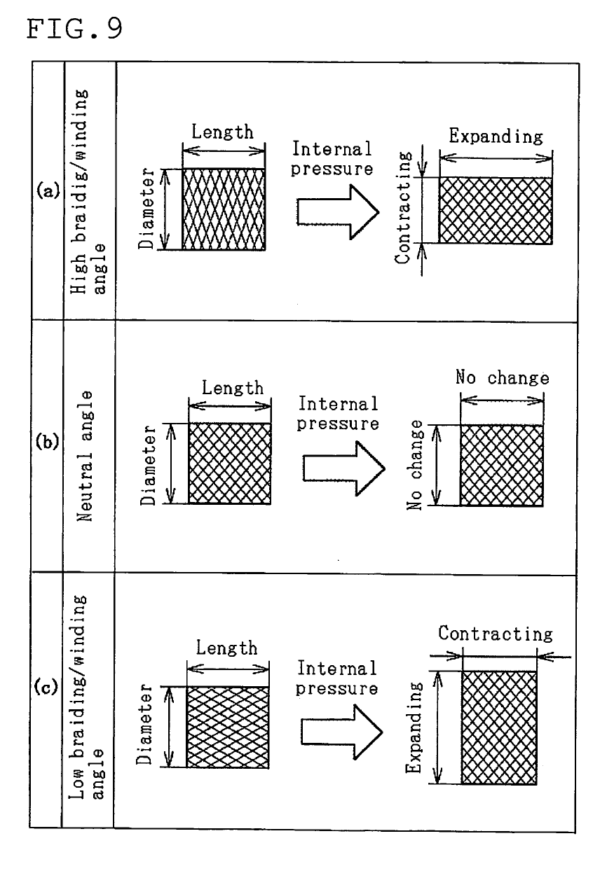

As shown in FIG. 7, a seal plug 40 is applied to one end while maintaining the hose in an approximately L-shaped bent state with a radius of 90 mm at a hose center, a hydraulic pressure is repeatedly supplied to the inner portion of the hose in a state in which both ends are fixed, and the durability is evaluated.

In this case, the hydraulic pressure is supplied repeatedly under a condition of pressure 3.5 MPa and a pressurizing speed 35 cpm.

The results are shown in Table 1 in addition.

In the results in Table 1, the braiding angles of the reinforcing yarn are 45 degree and 49 degree in both of the main portion and the caulked portion of the hose in the comparative embodiment A, respectively which are smaller than an angle (55 degree (neutral angle)±2 degree). Accordingly, although the mandrel mold inserting characteristic is comparatively better, the braiding angles are small and the braiding angles become nonuniform between the caulked portion and the main portion. Therefore, the pressurizing time length change rate comes to a larger value, and the high temperature repeated pressurizing durability comes to a low value at thirty thousands times.

Further, in the comparative embodiment B, since the braiding angle of the reinforcing yarn in the main portion of the hose is low 50 degree, the braiding angle of the reinforcing yarn in the caulked portion is 53 degree which exists in the lower limit value of an angle range (55 degree (neutral angle)±2 degree), and the braiding angles are nonuniform between the caulked portion and the main portion, the pressurizing time length change rate comes to a large value.

Further, the high temperature repeated pressurizing durability comes to two thousands times corresponding to the low value.

In this case, the evaluation of the inserting characteristic of the mandrel mold 32 under the 1 MPa pressurization comes to “acceptable” in the inserting characteristic of the mandrel mold 32 at the expanding time in the comparative embodiments A and B. This indicates that if the pressurizing force becomes higher than a fixed value, the resistance against the insertion of the mandrel mold 32 becomes large on the contrary.

On the other hand, in the comparative embodiment C, the winding (spirally winding) density of the reinforcing yarn in the main portion of the hose is low 18%. Accordingly, the RT bursting pressure is 2.4 corresponding to a significantly low value.

In this case, the mandrel mold inserting characteristic at the expanding time becomes “good”, however, this is caused by the matter that the expanding rate of the caulked portion is 13% corresponding to a low value.

On the contrary, in the embodiment 1 and the embodiment 2 in which both the braiding angles of the reinforcing yarn or both the winding angles of the reinforcing yarns in the main portion and the caulked portion of the hose exist within an angle range (55 degree (neutral angle)±2 degree), all of the mandrel mold inserting characteristic at the expanding time, the pressurizing time length change rate, the RT bursting pressure and the high temperature repeated pressure durability become “good”.

The description is in detail given above of the embodiment in accordance with the present invention, however, this is exemplified only as one example. The present invention can be carried out on the basis of variously modified aspects and structures within the scope of the present invention.

What is claimed is:

1. A high-pressure resistant vibration absorbing hose having a bursting pressure equal to or more than 5 MPa, comprising:
a hose main body having an inner surface side layer, a reinforcing layer formed by braiding or spirally winding a reinforcing filament member at a high braiding density equal to or more than 50% and arranged in an outer side of said inner surface side layer, and an outer surface layer arranged in an outer side of said reinforcing layer and corresponding to a cover layer, the hose main body being provided with a caulked portion on an axial end portion, and a main portion;
a joint device having a rigid insert pipe inserted in said caulked portion, and a sleeve-like socket metal fitting fitted to an outer surface of said caulked portion, the joint device being fixed to said caulked portion, by caulking said socket metal fitting fitted to the outer periphery of the caulked portion in a contracting direction;
said caulked portion of said axial end portion being formed in an expanded shape with respect to said main portion in a shape before caulking and fixing said joint device, and a braiding or winding angle of said reinforcing filament member in said reinforcing layer being set to 55 degree±2 degree equivalently in both of said main portion and said caulked portion formed in said expanded shape; and
a thickness of said inner surface side layer being equal to or more than 1 mm in the shape before caulking and fixing said joint device .

2. A manufacturing method of a high-pressure resistant vibration absorbing hose as defined in claim 1, comprising the steps of:
extrusion molding an inner surface side rubber layer corresponding to said inner surface side layer in a long straight tube shape,
thereafter braiding or spirally winding said reinforcing filament member in an outer periphery of said inner surface side rubber layer so as to continuously form said reinforcing layer, while braiding or winding said reinforcing filament member at a smaller angle than 55 degree±2 degree in a portion to be formed as said caulked portion , braiding or spirally winding said reinforcing filament member at an angle which is larger than the angle of said reinforcing filament member braided or spirally wound in the portion to be formed as said caulked portion , and is within a range of 55 degree±2 degree with respect to said main portion, and alternately repeating the braiding or spirally winding of said reinforcing filament member in the portion to be formed as said caulked portion and the braiding or spirally winding of said reinforcing filament member in said main portion in a longitudinal direction;
forming a long intermediate molded product by further extrusion molding an outer surface rubber layer corresponding to said outer surface layer in an outer periphery of said reinforcing layer;
cutting said intermediate molded product per a hose main body length at the portion to be formed as said caulked portion, thereafter intruding a mandrel mold to said axial end portion of a cut hose body so as to expand said axial end portion and form said caulked portion, and setting an angle of said reinforcing filament member at said caulked portion to 55 degree±2 degree; and
thereafter applying a vulcanizing process so as to obtain said high-pressure resistant vibration absorbing hose.

3. A manufacturing method of a high-pressure resistant vibration absorbing hose as set forth in claim 2, wherein said intermediate molded product or said cut hose body is semi-vulcanized prior to the intrusion of said mandrel mold.

4. A manufacturing method of a high-pressure resistant vibration absorbing hose as set forth in claim 2, wherein the intruding of said mandrel mold for expanding and deforming said axial end portion is executed while constraining and holding an outer surface of said main portion by a holding mold.

5. A manufacturing method of a high-pressure resistant vibration absorbing hose as set forth in claim 4, wherein the intruding of said mandrel mold is executed in a state in which an internal pressure is applied to said cut hose body.
